(19) United States
(12) Patent Application Publication
(10) Pub. No.: US 2022/0171889 A1
(43) Pub. Date: Jun. 2, 2022

(54) CONTROLLING DISPLAY DEVICES BASED ON VIEWING ANGLES

(71) Applicant: Hewlett-Packard Development Company, L.P., Spring, TX (US)

(72) Inventors: Hsiang Ta Ke, Taipei City (TW); Li-Jen Lee, Taipei City (TW)

(73) Assignee: Hewlett-Packard Development Company, L.P., Spring, TX (US)

(21) Appl. No.: 17/418,798

(22) PCT Filed: Aug. 12, 2019
(86) PCT No.: PCT/US2019/046216

§ 371 Date: Jun. 26, 2021

(51) Int. Cl. G06F 21/84; G06V 40/18; G09G 3/20

(52) U.S. Cl. CPC G06F 21/84; G06V 40/193; G09G 2320/068; G09G 2358/00; G09G 2354/00; G09G 3/20

(57) ABSTRACT

Techniques for controlling a display device of a computing device based on a viewing angle are described. According to an example of the present subject matter, a viewing angle corresponding to the pair of eyes directed towards the display device is determined. In an example, the viewing angle may be an angle between a first plane corresponding to a horizontal line drawn between the pair of eyes and a second plane corresponding to a horizontal line drawn at a center of the display device of the computing device. An action to control the display device may be performed based on the viewing angle corresponding to the pair of eyes.

### BACKGROUND

Computing devices, such as desktops, laptops, mobiles phones, tablets, and handheld personal computers (PC) offer a computing platform for various applications to run. An application running on a computing device generally receives input from through a user interface and renders output to a user of the computing device on a display which is coupled to such a computing device.

### BRIEF DESCRIPTION OF DRAWINGS

The detailed description is described with reference to the accompanying figures. It should be noted that the description and figures are merely examples of the present subject matter and are not meant to represent the subject matter itself.

FIG. 1 illustrates a computing device, enabling protection of content displayed on a display device of the computing device from unauthorized viewing, according to an example implementation of the present subject matter.

FIG. 2 illustrates a viewing angle, in accordance with another example implementation of the present subject matter.

FIG. 3 illustrates a computing device to control display of content based on a viewing angle, in accordance with another example implementation of the present subject matter.

FIG. 4 illustrates a method for protecting content displayed on a display device of a computing device from unauthorized viewing, according to an example of the present subject matter.

FIGS. 5a and 5b illustrate a method for controlling a display device based on a viewing angle, according to an example of the present subject matter.

FIG. 6 illustrates a computing environment for protecting content displayed on a display device of a computing device from unauthorized viewing based on a viewing angle, according to an example implementation of the present subject matter.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Computing devices generally include a display device for displaying contents rendered by applications executing on the computing device. Individuals in the vicinity to the computing device may potentially view the contents rendered on the display device. However, some contents may be confidential to a user of the computing device and thus, the user may not want other individuals to view the contents the user is viewing. For instance, in case the user is chatting with someone, browsing some confidential information and the like, he may not want others to view the contents of their conversation or their browsing activities.

As such the content displayed on the display device is prone to sniffing, since any individual in a position to view the content displayed on the display device may do so and cause breach of privacy of the user's. The user may avoid the sniffing of confidential contents by minimizing the application rendering the contents. However, it is difficult for the user of the computing device, whose face is directed towards the display device, to determine a presence of another individual in the vicinity of the display device, more so if the potential sniffer is behind the user.

Generally, in order to protect the content that the user of the computing device is viewing, from unauthorized viewing, the presence of the potential sniffer in the vicinity of the display device may be automatically detected and consequently, an action to control the display device may automatically be performed. For the purpose, techniques, such as proximity sensing may be employed. In some cases, images of area in the vicinity of the computing device may be captured through a camera coupled with the computing device. The captured images may be processed to detect the presence of individuals in the vicinity of the display device. If an individual is detected to be within a threshold distance from the computing device, the display may be controlled. For example, the display may be switched off on detecting any individual other than the authorized user within a predefined distance.

However, it is likely that an individual, whose presence has been detected may not be viewing the contents displayed on the display device. For example, a person may just be passing within the proximity of the display device and may not be seeking to view the contents on the display device. In such cases, automatically controlling the display device, may be annoying for the authorized user who is viewing the information.

Accordingly, while manual detection by the user to avoid the sniffing of the contents displayed on the display device by the potential sniffer may not be effective since the user may not be aware of the presence of the potential sniffer and may also cause inconvenience to the user, thus, generally employed automatic detection techniques may often adversely affect the user experience.

The present subject matter provides automatically controlling the display devices based on a viewing angle of individuals potentially viewing the display devices. Controlling the display device protects the content displayed on display devices from unauthorized viewing by potential sniffers. The present subject matter discloses example implementations of techniques enabling protection of content displayed on a display device based on determining viewability of the display device by an individual.

In an example implementation of the present subject matter, an image captured by an image capturing device coupled is analyzed to determine a whether the individual under consideration is potentially viewing a display device. A portion of the image corresponding to a pair of eyes of at least one of the plurality of individuals is extracted. Further, a viewing angle corresponding to the pair of eyes is determined. The viewing angle may be defined by a first line that is orthogonal to a horizontal line drawn between the pair of eyes with respect to a second line that is orthogonal to a horizontal line drawn at a centre of the display device of the computing device. The display device is controlled based on the viewing angle corresponding to the pair of eyes.

The present subject matter enables reliably determining whether any of the plurality of individuals, determined to be in the vicinity of the display device based on the image captured by the camera, is viewing the content displayed on the display device, interruptions which may be caused to a user, who is viewing the content, if the display device is controlled merely on the basis of detection of a presence of an individual in the vicinity of the display device, may thus be avoided.

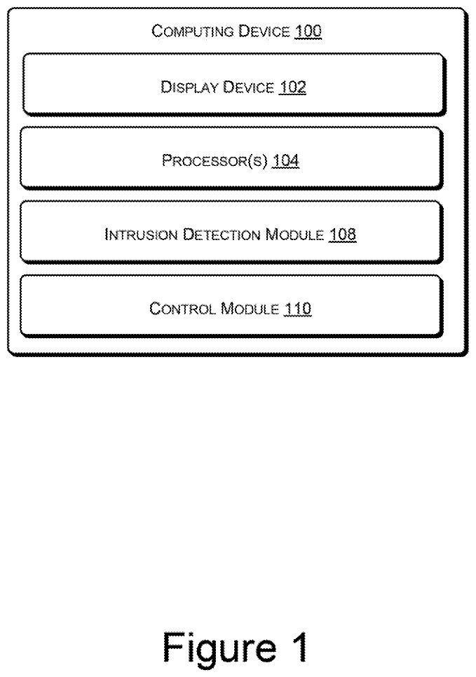

The above techniques are further described with reference to FIG. 1 to FIG. 6. It should be noted that the description and the figures merely illustrate the principles of the present subject matter along with examples described herein and should not be construed as limiting the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 shows a computing device 100 enabling protection of content displayed on a display device 102 of the computing device 100 from unauthorized viewing, according to an example implementation of the present subject matter. Examples of the computing device 100 may include, but are not limited to, an electronic device, such as a desktop computer, a personal computer, a laptop, a smartphone, a personal digital assistant (PDAs), and a tablet.

In an example, the display device 102 may be a visual display unit (VDU), such as a screen or a monitor that may be integral to the computing device 100 or may be coupled to the computing device 100.

A processor 104 of the computing device 100 may control the display device 102, such that content displayed on the display device 102 is not subjected to unauthorized viewing. In an example, the processor 104 may be implemented as microprocessors, microcomputers, microcontrollers, digital signal processors, central processing units, state machines, logic circuitries, and/or any devices that manipulate signals based on operational instructions. Among other capabilities, the processor 104 is configured to fetch and execute computer-readable instructions stored in a memory (not shown in FIG. 1) of the computing device 100.

To implement techniques to protect the content displayed on the display device 102, the processor 104 is interfaced with a camera 106 (not shown in FIG. 1) operable in conjunction with the computing device 100 to capture images or video. In an example, the camera 106 may be inbuilt or integrated into the computing device 100, such as a webcam. A webcam may be a complementary metal-oxide semiconductor (CMOS) camera in an example. Although not shown, in an example, the camera 106 also includes an external camera coupled to the computing device 100, such as an external webcam coupled to the computing device 100 through a universal serial bus (USB).

In accordance with an example implementation of the present subject matter, the computing device 100 comprises an intrusion detection module 108, coupled to the processor 104. The intrusion detection module 108 is operable to analyze, an image received from the camera 106, to determine a plurality of individuals to be potentially viewing the display device 102. Based on determining a plurality of individuals to be potentially viewing the display device 102, the intrusion detection module 108 extracts a portion of the image, wherein the extracted portion includes an image of a pair of eyes of an individual. The intrusion detection module 108 is further operable to determine a viewing angle corresponding to the pair of eyes. The viewing angle may be understood as an angle that eyes of an individual viewing the display device 102 make with the display device 102. In an example, the viewing angle may be defined as an angle that a first line, orthogonal to a horizontal line drawn between the pair of eyes, makes with respect to a second line orthogonal to a horizontal line drawn at a center of the display device 102 of the computing device 100.

A control module 110, coupled to the processor 104 and the intrusion detection module 108 controls the display device 102 based on the viewing angle corresponding to the pair of eyes. For instance, if the determined viewing angle is such that a likelihood of the pair of eyes to be viewing the content exists, the display device 102 may be controlled to alter or pause the display. In an example, the intrusion detection module 108 may not take any control action if the pair of eyes are detected to be that of an authorized user associated with the computing device 100.

Thus, the present subject matter protects content displayed on the display device 102 from unauthorized viewing by a potential sniffer by controlling the display device 102 based on a detection of a presence of an individual, other than the authorized user, who is able to view the information. According to the present subject matter, the display device 102 is controlled based on a determination that the individual is able to view the content displayed on the display device 102 and not merely on presence of such an individual to minimize disturbances that may be caused to an authorized user viewing the content.

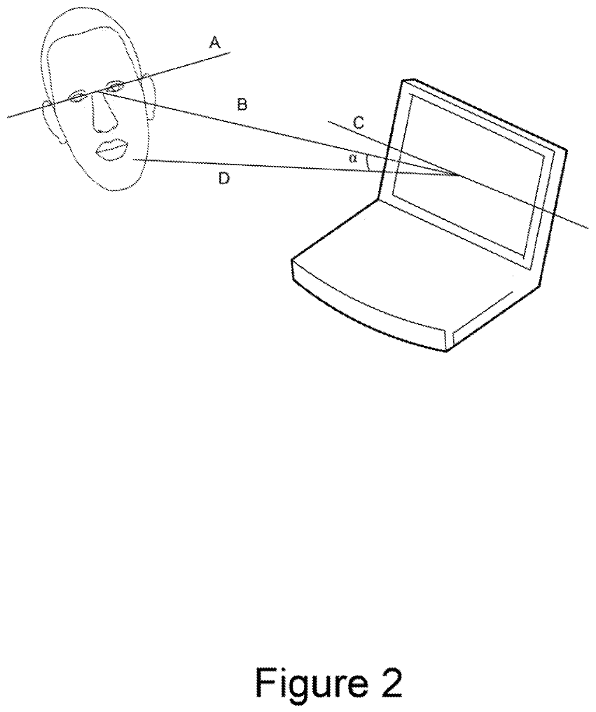

Reference is now made to FIG. 2 that illustrates a viewing angle, depicted as ‘α’, that the eyes of an individual may make with a display device, such as above-described display device 102 of the computing device 100. The viewing angle α may be defined as an angle that a first line B, orthogonal to a horizontal line A passing through a center of the pair of eyes, makes with respect to a second line D that is orthogonal to a horizontal line C drawn at a center of the display device 102.

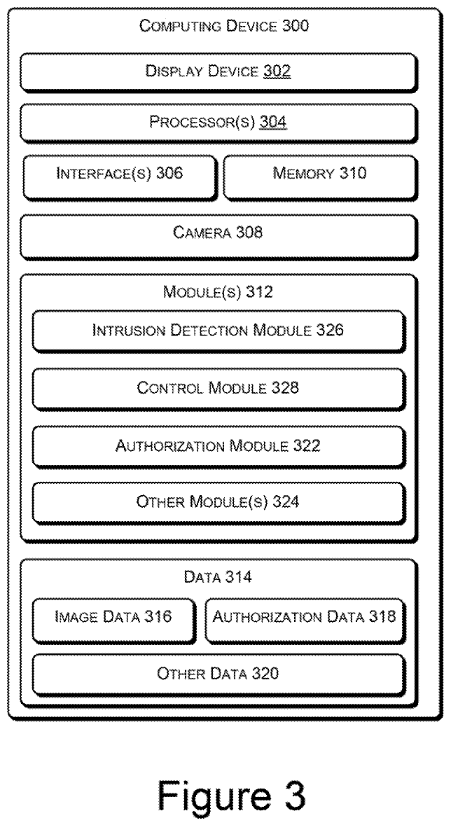

FIG. 3 illustrates a computing device 300 to control display of content on a display device 302 of the computing device 300 based on a viewing angle, in accordance with another example implementation of the present subject matter. The computing device 300 may be similar to the above-described computing device 300 and may comprise a processor 304 communicatively coupled to the display device 302. In an example, the processor 304 may be similar to the processor 104 in implementation and functionality.

As depicted in FIG. 3, in an example implementation, interface(s) 306 may be coupled to the processor 304. The interface(s) 306 may include a variety of software and hardware interfaces that allow interaction of the computing device 300 with other communication and computing devices, such as network entities, web servers, and external repositories, and peripheral devices. The interface(s) 306 may also enable coupling of internal components of the computing device 300 with each other. For example, the interface(s) 306 may couple the display device 302 to the processor 304. Likewise, the interface(s) 306 may couple a camera 308 of the computing device 300 to the processor 304.

It would be understood that while in the example implementation illustrated in FIG. 3, the display device 302 and the camera 308 are integral to the computing device 300, other implementations where either or both of these components are external to the computing device 300, are also feasible. In such cases, the interface(s) 306 may serve to communicatively couple the external camera or display device to the computing device 300.

Further, the computing device 300 comprises a memory 310 coupled to the processor 304. The memory 310 may include any computer-readable medium known in the art including, for example, volatile memory (e.g., RAM), and/or non-volatile memory (e.g., EPROM, flash memory, etc.). The memory 310 may also be an external memory unit, such as a flash drive, a compact disk drive, an external hard disk drive, or the like. The computing device 300 may comprise module(s) 312 and data 314 coupled to the processor 304. In one example, the module(s) 312 and data 314 may reside in the memory 310.

In an example, the data 314 may comprise an image data 316, an authorization data 318 and other data 320. The module(s) 312 may include routines, programs, objects, components, data structures, and the like, which perform particular tasks or implement particular abstract data types. The module(s) 312 further include modules that supplement applications on the computing device 300, for example, modules of an operating system. The data 314 serves, amongst other things, as a repository for storing data that may be fetched, processed, received, or generated by one or more of the module(s) 312. The module(s) 312 may include an authorization module 322 and other module(s) 324, in addition to an intrusion detection module 326 and a control module 328 that may be similar to the aforementioned intrusion detection module 108 and control module 110, respectively, in function and implementation. The other module(s) 324 may include programs or coded instructions that supplement applications and functions, for example, programs in the operating system of the computing device 300.

In an example, the computing device 300 is operable to protect content displayed on the display device 302 from unauthorized viewing by potential sniffers. For the purpose, the display device 302 is controlled based on a viewing angle of a potential sniffer viewing the display device 302.

Accordingly, in operation, once the computing device 300 is initiated, for example, to execute an application that may render content on the display device 302, the intrusion detection module 326 may cause the camera 308 to capture images or videos of people and things that may be present in field of view of the camera 308. In an example, the camera 308 may be implemented, such that a field of view of the camera 308 corresponds to an area in front of the display device 302, such that an individual who may potentially view the display device 302 is within the field of view of the camera 308. The image or series of images, comprising a video, captured by the camera 308, may be stored as image data 316 in the data 314 of the computing device 300.

The intrusion detection module 326 may retrieve the image data 316 and analyze the images captured by the camera 308. In an example, the intrusion detection module 326 may detect an individual to be present in front of the display device 302 by analyzing the images. For instance, to determine presence of the individual, the intrusion detection module 326 may implement face detection techniques to detect human faces. In an example, the intrusion detection module 326 may use Haar face detection method.

In case a single face is detected in the image and presence of one individual is determined, the intrusion detection module 326 may invoke the authorization module 322 to determine if the individual is an authorized user of the computing device 300. The authorization module 322 may implement a variety of techniques, such as biometric and image-processing based techniques to identify the authorized user.

In one example, the authorized user may have previously registered himself with the computing device 300. The authorization module 322 may have captured authorization data 318 corresponding to the authorized user during a registration process. In an example, the authorization data 318 may include biometric features of the authorized user. The biometric features may include, but not limited to, geometrical features of the face of the authorized user or features of a retina or iris of the authorized user. Accordingly, the authorization data 318 may include reference images of the face or eyes of authorized user. The authorization module 322 may compare the biometric features of the authorized user, extracted from the reference images, to the biometric features extracted from the image of the individual captured by the camera 308. The authorization module 322 may identify the individual as the authorized user if at least one biometric feature of the authorized user matches with a corresponding biometric feature of the individual in the image.

If the authorization module 322 determines the individual detected in the image to be the authorized user of the computing device 300, the viewing angle corresponding to the pair of eyes of the authorized user may not be calculated and consequently the control module 328 may not take any action to control the display device 302. However, in case the single individual detected in the image is determined not to be the authorized user, or, in case, at least one individual other than the authorized user is detected based on the analysis of the images, the intrusion detection module 326 performs further operations to determine if the displayed content is being sniffed by the at least one individual other than the authorized user, interchangeably referred to as a potential sniffer hereinafter.

For the purpose, as mentioned previously, the intrusion detection module 326 determines a viewing angle corresponding to the potential sniffer. For determination of the viewing angle, the intrusion detection module 326 may extract a portion of the image corresponding to a pair of eyes of the potential sniffer. In an example, to extract the portion of the image corresponding to the pair of eyes of the potential sniffer, the intrusion detection module 326 may reduce the image in size to a region surrounding the eyes, using cropping tools. Also, in an example, if the image is a color image, comprising Red, Green, Blue (RGB) components, the cropped image may be converted from a color image to a greyscale image with 255 levels of intensity. Cropping and converting the color image into the greyscale image, may reduce amount of data in the image to be processed in order to determine the viewing angle corresponding to the pair of eyes, while retaining much of the information that allows the determination to be made.

From the extracted portion of the image corresponding to the pair of eyes, a location of the centers of each of the eye in the pair of eyes may be determined. For example, the cropped greyscale image may be subjected to Hough transform to identify the respective center of each eye. Based on determination of the centers of the eyes, the intrusion detection module 326 defines a horizontal line drawn between the pair of eyes, such that the horizontal line passes through the center of each of both the eyes. The intrusion detection module 326 thereupon computes the viewing angle as an angle that a plane defined by the horizontal line, makes with respect to a horizontal plane along a center of the display device 302.

In an example implementation, the intrusion detection module 326 determines whether the viewing angle is less than a first threshold value. In an example, the first threshold value for the viewing angle may be an angle in the range of about 55 degrees to 65 degrees. In another example, the first threshold value may be 60 degrees. Accordingly, if, the viewing angle determined for the potential sniffer is less than the first threshold value, the individual may be identified as an intruder or a sniffer who may be able to view the contents displayed on the display device 302.

Based on the viewing angle, once the presence of the intruder is detected, to control the display device 302, the control module 328 may cause a foreground application running on the computing device 300 and being displayed on the display device 302 to be minimized. Alternatively, or additionally, the control module 328 may cause the display device 302 to display a message to alert the authorized user about the intrusion. In another example, if viewing angle is determined to be less than the first threshold value, the control module 328 may lock the computing device 300.

In one example, the intrusion detection module 326 also determines if the viewing angle determined for the potential sniffer is less than a second threshold value, wherein the second threshold value is less than the first threshold value. If viewing angle is determined to be even less than the second threshold value, the control module 328 may cause the camera 308 to capture the image of the potential sniffer. In an example, the second threshold value may be 30 degrees, or may be in a range of about 35 degrees to 35 degrees.

In an example, the image of potential sniffer captured by the camera 308 may be stored in image data 316. The stored image may be used to deter potential attempts of unauthorized viewing by the potential sniffer. For instance, the authorization module 322 may identify a potential sniffer based on an image of the potential sniffer captured during a previous instance of sniffing and may invoke any one of the above-explained control actions.

While the above techniques for preventing unauthorized viewing of the content displayed on the display device 302 is provided in context of one authorized user and one potential sniffer, the same may be extended, mutatis mutandis, to situations where there may be more than one authorized users and more than one potential sniffers.

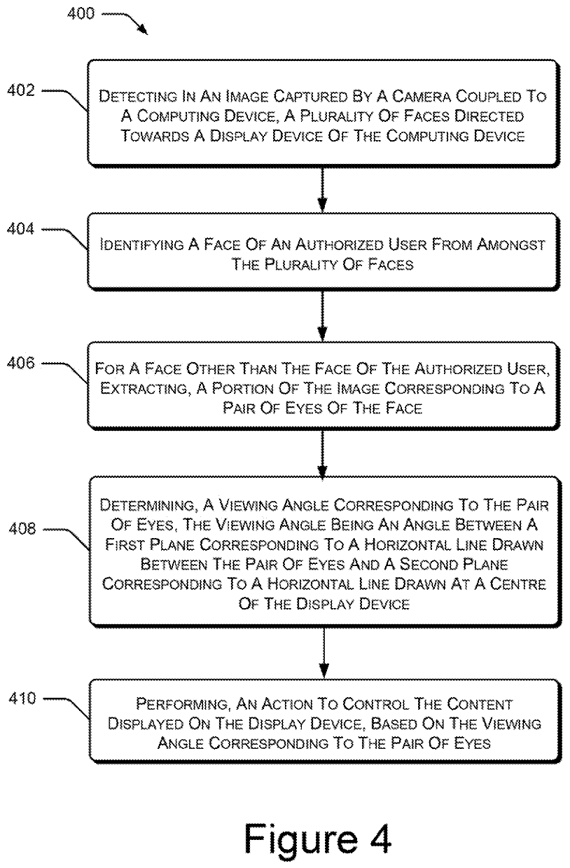

FIG. 4 illustrates a method 400 for protecting content displayed on a display device of a computing device from unauthorized viewing, according to an example implementation of the present subject matter. Although the method 400 may be implemented in a variety of electronic devices, for ease of the explanation, the present description of the method 400 is provided in context of the above-described display device 302 of the computing device 300. In an example, the method 400 may be implemented by a processor(s) or computing device(s) through any suitable hardware, non-transitory machine-readable instructions, or combination thereof.

It may be understood that blocks of the method 400 may be performed by programmed computing devices. The blocks of the method 400 may be executed based on instructions stored in a non-transitory computer readable medium, as will be readily understood. The non-transitory computer readable medium may include, for example, digital memories, magnetic storage media, such as magnetic disks and magnetic tapes, hard drives, or optically readable digital data storage media.

Referring to FIG. 4, at block 402, a plurality of faces directed towards the display device 302 are detected in an image captured by a camera, for example, camera 308 associated with the computing device 300. For instance, plurality of individuals may be present in the image captured by the camera 308 whose field of view may correspond to an area in front of the display device 302. The plurality of faces may be detected using various face detection techniques, such as the Haar face detection method.

At block 404, a face of an authorized user is identified from amongst the plurality of faces. In an example implementation, to identify the face of the authorized user, the image captured by the camera 308 may be compared to a prestored reference images of the authorized user.

At block 406, after identifying the face of the authorized user from amongst the plurality of faces, for a face other than the face of the authorized user, a portion of the image corresponding to a pair of eyes of the face is extracted. As mentioned previously, to extract the portion of the image corresponding to the face, the image may be reduced to a region surrounding the pair of eyes, using cropping tools.

At block 408, a viewing angle corresponding to the pair of eyes is determined. The viewing angle may be understood as an angle that the pair of eyes corresponding to a face directed towards the display device 102, makes with the display device 302. In an example, the viewing angle may be defined as an angle between a first plane corresponding to a horizontal line drawn between the pair of eyes and a second plane corresponding to a horizontal line drawn at a center of the display device 302.

At block 410, based on the determination of the viewing angle corresponding to the pair of eyes, an action to control the content displayed on the display device 302 is performed. For example, if viewing angle is determined to be such that the contents displayed on the display device 302 may be susceptible to sniffing, the display may be paused to prevent the sniffing.

In some of the cases, it may be desirable that more than one individuals, including or other than the authorized user are allowed to view the contents displayed on the display device. For example, if two or more individuals are watching a movie or the contents displayed on the display device 302, the display may not be controlled, even if the viewing angle corresponding to a pair of eyes of any of the individuals is determined to be less than the first threshold value. Accordingly, a predefined sensitivity level may be associated with a foreground application running on the computing device 300.

In an example, the intrusion detection module 326 may associate a sensitivity level with the various applications that may reside in the operating system of the computing device 300, based on a user-input. In another example, the intrusion detection module 326 may assign a default sensitivity level that may be defined for an application, for example, based on whether the application operates on confidential information or otherwise. For example, an application that may allow a user to view publicly available images and videos may be assigned a low sensitivity level, while an application that may allow a user to exchange personal messages with other users may be assigned a high sensitivity level.

In an example, to control the content displayed on the display device 302, the predefined sensitivity level associated with the foreground application may be determined, for example, by the control module 328. Based on the sensitivity level the control actions may be taken or skipped.

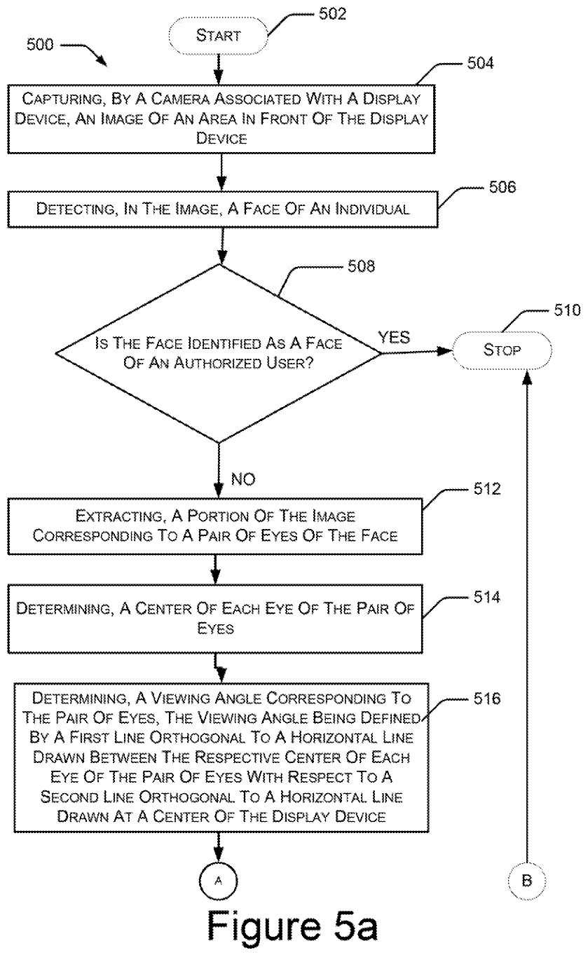

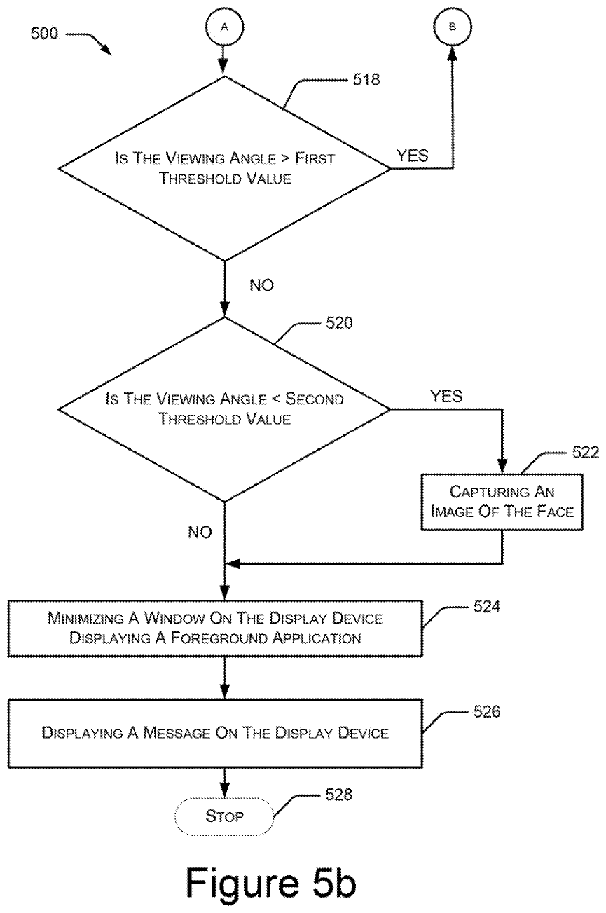

FIGS. 5a and 5b illustrate a method 500 for controlling a display device based on a viewing angle, according to an example of the present subject matter. Although the method 500 may be implemented in a variety of electronic devices, as is the case with method 400, for the ease of explanation, the method 500 is described in reference to the computing device 300 comprising the display device 302.

In an example, the method 500 may be implemented by a processor(s) or computing device(s) through any suitable hardware, non-transitory machine-readable instructions, or combination thereof. It may be understood that blocks of the method 500 may be performed by programmed computing devices. The blocks of the method 500 may be executed based on instructions stored in a non-transitory computer readable medium, as will be readily understood. The non-transitory computer readable medium may include, for example, digital memories, magnetic storage media, such as magnetic disks and magnetic tapes, hard drives, or optically readable digital data storage media.

Referring to FIG. 5a, the method 500 is initiated at block 502, and, at block 504, an image of an area in front of the display device 302 may be captured by a camera associated with a display device, for example, by the camera 308. The image is analyzed, at block 506, to detect a face of an individual who may have been present in the area in front of the display device 302 and may have consequently been captured in the image. At block 508, a determination is made as to where the face in the image is of an authorized user. In case the assessment is in the affirmative, the method 500 proceeds to block 510 where the method 500 is terminated. However, if at block 508, it is determined that the face is not of an authorized user, the method 500 proceeds to block 512.

At block 512, a portion of the image corresponding to a pair of eyes of the face is extracted, for example, by cropping the image. Thereafter, at block 514, a center of each eye of the pair of eyes is determined, for example, using Hough transform. A viewing angle corresponding to the pair of eyes is determined at block 516, by computing an angle that a first line orthogonal to a horizontal line, drawn between the respective center of both the eyes, makes with respect to a second line orthogonal to a horizontal line drawn at a center of the display device 302.

The viewing angle being determined, the method 500 proceeds to block 518. Reference is made to FIG. 5b, wherein, at block 518, a determination is made as to whether the viewing angle is greater than a first threshold value. In an example, the first threshold value may be in the range of about 55 degrees to 65 degrees. If the viewing angle is found to be greater than the first threshold value, the method 500 proceeds to block 510 where the method 500 is terminated. As would be understood, for a viewing angle greater than the first threshold value, for example, for a viewing angle of sixty degrees or more, it may be considered that the eyes of a potential sniffer are positioned such that the potential sniffer is unable to view the display device 302. Accordingly, the method 500 may not perform a control action in such cases.

On the other hand, if the viewing angle is found to be less than the first threshold value, it may be considered that eyes of a potential sniffer are positioned so as to be able to view the display device 302. In such cases, a control action may be taken in accordance with the determined viewing angle. Accordingly, the method 500 proceeds to block 520 where a further assessment is made to determine if the viewing angle is less than a second threshold value. In an example, the second threshold value may be in a range of about 25 degrees to 35 degrees. If the viewing angle is found to be less than the second threshold value, the likelihood of the potential sniffer to be viewing the content may be considered higher than when the viewing angle is less than the first threshold value but higher than the second threshold value.

Accordingly, if the assessment at block 520 reveals that the viewing angle is less than the second threshold value, at block 522, an image of the face is captured. As discussed previously, the image captured at block 522, may be enable the computing device 300 to identify the potential sniffer in future. After the image is captured, the method 500 proceeds to block 524 and thereafter to block 526 where further control actions may be implemented. Also, in case the assessment at block 520 indicates that the viewing angle is greater than the second threshold value, the method 500 proceeds to block 524 and block 526.

At block 524, the control action involves minimizing a window on the display device 302 displaying a foreground application while, at block 526 the control action involves displaying a message on the display device 302. In an example, both the control actions of block 524 and block 526 may be performed simultaneously. In other examples, either of the control actions of block 524 and block 526 may be performed to protect the content from unauthorized viewing. Once the control action is performed, the method 500 may end at block 528.

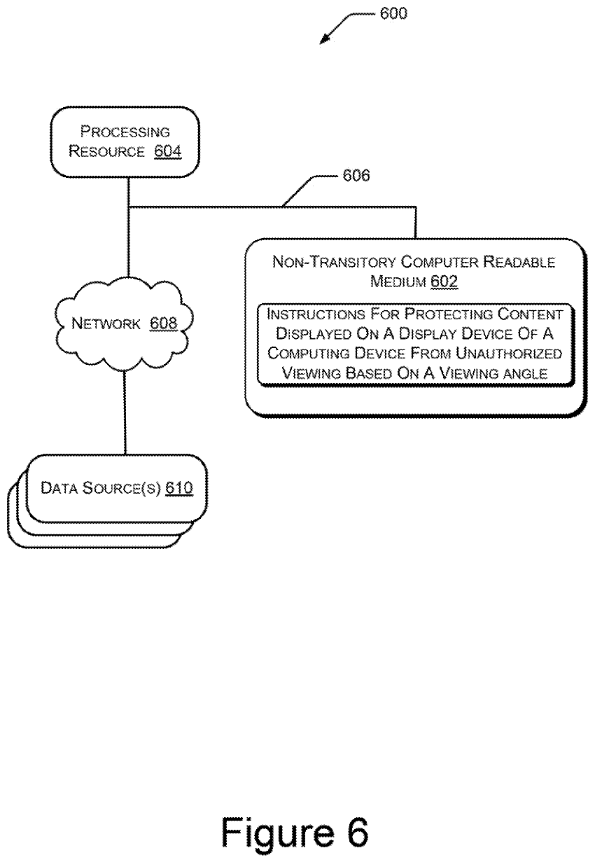

FIG. 6 illustrates an example system environment 600 implementing a non-transitory computer readable medium for protecting content displayed on a display device of a computing device from unauthorized viewing based on a viewing angle, in accordance with an example of the present subject matter. In one exemplary implementation, the system environment 600 includes a processing resource 604 communicatively coupled to a non-transitory computer readable medium 602 through a communication link 606. In an example, the processor resource 602 fetches and executes computer-readable instructions from the non-transitory computer-readable medium 602.

For example, the processing resource 604 can be a processor of a computing device, such as the computing device 100 or the computing device 300. The non-transitory computer readable medium 602 can be, for example, an internal memory device or an external memory device. In one implementation, the communication link 606 may be a direct communication link, such as one formed through a memory read/write interface. In another implementation, the communication link 606 may be an indirect communication link, such as one formed through a network interface. In such a case, the processing resource 604 can access the non-transitory computer readable medium 602 through a network 608. The network 608 may be a single network or a combination of multiple networks and may use a variety of different communication protocols.

The processing resource 604 and the non-transitory computer-readable medium 602 may also be communicatively coupled to data source(s) 610. The data source(s) 610 may be used to store data, such as image data captured by a camera to capture videos or images or individual potentially viewing the display device and authorization data of authorized users of the computing device, in an example.

In an example implementation, the non-transitory computer-readable medium 602 includes a set of computer-readable instructions for controlling the display device of the computing device based on a viewing angle. The set of computer-readable instructions can be accessed by the processing resource 604 through the communication link 606 and subsequently executed to protect content displayed on a display device of the computing device from unauthorized viewing based on a viewing angle.

In an example, the non-transitory computer-readable medium 602 may include a set of instructions that may, in one example, be executable by the by the processing resource 604 to detect, in a sequence of images of a first individual viewing the display device, a change in a current image with respect to a previous image in the sequence of images, the change being indicative of entry of a second individual. In an example, the first person may be an authorized user. To detect the entry of one more individual in the current image with respect to the previous image, motion detection techniques may be used. In an example, colors of pixels of the previous image and the current image may be compared. If the number of pixels having different color value exceeds a predefined value, it may be determined that an individual other than the first individual present in the previous image is in the area in front of the display device.

If the second individual is detected to be present in the current image, the non-transitory computer-readable medium 602 may include a set of instructions that may, in one example, be executable by the processing resource 604 to extract a portion of the current image corresponding to a pair of eyes of the second individual. As explained previously, to extract, the portion of the image corresponding to the pair of eyes of the second individual, face of the second individual may be detected using a face detection technique, for example, Haar face detection technique. Accordingly, the portion of the current image corresponding to the pair of eyes of the face of the second individual can be extracted.

The non-transitory computer-readable medium 602 may further include a set of instructions that may, in one example, be executable by the processing resource 604 to determine, a viewing angle corresponding to the pair of eyes of the second individual. As explained previously, the viewing angle may be defined by a first plane vertical to a horizontal line drawn between the pair of eyes with a second plane vertical to a center of the display device of the computing device.

Based on the viewing angle corresponding to the pair of eyes of second individual, the non-transitory computer-readable medium 602 may cause the processing resource 604 to control the display device. To identify whether the second individual is able to view the content displayed on the display device, the non-transitory computer-readable medium 602 may further include a set of instructions that may, in one example, be executable by the processing resource 604 to determine whether the viewing angle corresponding to the second individual is less than a first threshold value.

In case the viewing angle is determined to be less than a first threshold value, the display is controlled. To control the display device the non-transitory computer-readable medium 602 may further include a set of instructions that may, in one example, be executable by the processing resource 604 to minimize a foreground application running on the computing device and cause to display a warning message on the display device.

In an example, the set of instructions also causes the processing resource to determine if the viewing angle for the second individual is less than a second threshold value. The second threshold value is less than the first threshold value. The non-transitory computer-readable medium 602 may further include a set of instructions that may, in one example, be executable by the processing resource 604 to cause a camera associated with the display device to capture an image of the second individual, if the viewing angle is determined to be less than a second threshold value. As mentioned previously, the image of the second individual may be stored in image data to prevent any further attempt of sniffing that may be made by the second individual.

Thus, the methods and devices of the present subject matter provide for protecting content displayed on display devices from unauthorized viewing by potential sniffers by automatically controlling the display devices based on a viewing angle of individuals potentially viewing the display devices. Although implementations of protecting content displayed on display devices from unauthorized viewing have been described in a language specific to structural features and/or methods, it is to be understood that the appended claims are not necessarily limited to the specific features or methods described. Rather, the specific features and methods are disclosed as example implementations for protecting content displayed on display devices from unauthorized viewing.

1. A computing device comprising:
a display device;
a processor; and
an intrusion detection module, coupled to the processor, to:
analyze an image received from a camera coupled to the computing device to determine a plurality of individuals to be potentially viewing the display device;
extract a portion of the image, wherein the extracted portion includes an image of a pair of eyes of at least one of the plurality of individuals;
determine, a viewing angle corresponding to the pair of eyes, wherein the viewing angle is an angle between a first line orthogonal to a horizontal line drawn between the pair of eyes with respect to a second line which is orthogonal to a horizontal line drawn at a center of the display device of the computing device; and
a control module, coupled to the processor, to:
control the operation of the display device based on the viewing angle corresponding to the pair of eyes.

2. The computing device as claimed in claim 1, further comprises an authorization module, coupled to the processor to:
identify an authorized user from amongst the plurality of individuals, wherein
the intrusion detection module is to determine the viewing angle for at least one of the plurality of individuals other than the authorized user.

3. The computing device as claimed in claim 2, wherein the intrusion detection module is to further:
determine, for at least one of the plurality of individuals other than the authorized user, whether the viewing angle is less than a first predefined threshold value; and
detect presence of an intruder based on the determination.

4. The computing device as claimed in claim 1, wherein the control module is to:
cause the camera to capture an image of the at least one of the plurality of individuals, if the viewing angle is less than a second predefined threshold value, the second predefined threshold value being less than the first predefined threshold value.

5. The computing device as claimed in claim 1, wherein to control the display device, the control module is to affect one of:
minimize display a foreground application running on the computing device; and
cause to display a warning message on the display device.

6. The computing device as claimed in claim 1, wherein the line orthogonal to the horizontal line drawn between the pair of eyes is defined using a Hough transform.

7. A method for protecting content displayed on a display device of a computing device from unauthorized viewing, the method comprising:
detecting, in an image captured by a camera coupled to the computing device, a plurality of faces directed towards the display device;
identifying a face of an authorized user from amongst the plurality of faces;
for a face other than the face of the authorized user, extracting, a portion of the image corresponding to a pair of eyes of the face;
determining, a viewing angle corresponding to the pair of eyes, the viewing angle being an angle between a first plane corresponding to a horizontal line drawn between the pair of eyes and a second plane corresponding to a horizontal line drawn at a center of the display device of the computing device;
performing, an action to control the content displayed on the display device, based on the viewing angle corresponding to the pair of eyes.

8. The method as claimed in claim 7 further comprising:
determining, for the face other than the face of the authorized user, whether the viewing angle is less than a first predefined threshold value; and
detecting presence of an intruder based on a determination that the viewing angle is less than a first predefined threshold value.

9. The method as claimed in claim 7 further comprising:
capturing an image comprising the face other than the face of the authorized, if the viewing angle is less than a second predefined threshold value, the second predefined threshold value being less than the first predefined threshold value.

10. The method as claimed in claim 7, wherein performing the action to control the content displayed on the display device comprises:
displaying a message on the display device to alert the authorized user of an intrusion.

11. The method as claimed in claim 7, wherein performing the action to control the content displayed on the display device comprises:
determining, a predefined sensitivity level associated with a foreground application running on the computing device; and
minimizing a window on the display device displaying the foreground application, based on the predefined sensitivity level.

12. A non-transitory computer-readable medium comprising computer-readable instructions executable by a processing resource to:
detect, in a sequence of images of a first individual viewing a display device, a change in a current image with respect to a previous image in the sequence of images, the change being indicative of entry of a second individual;
extract a portion of the current image corresponding to a pair of eyes of the second individual;
determine, a viewing angle corresponding to pair of eyes, the viewing angle being defined by a plane vertical to a horizontal line drawn between the pair of eyes with a plane vertical to a center of the display device of the computing device; and
control the display device based on the viewing angle corresponding to the pair of eyes.

13. The non-transitory computer-readable medium as claimed in claim 12 further comprising computer-readable instructions executable by the processing resource to:
determine, for the second individual, whether the viewing angle is less than a predefined threshold value.

14. The non-transitory computer-readable medium as claimed in claim 12, wherein to control the display device, the computer-readable instructions are executable by the processing resource to:
minimize a foreground application running on the computing device; or
display a warning message on the display device.

15. The non-transitory computer-readable medium as claimed in claim 12, further comprise computer-readable instructions executable by the processing resource to:
cause a camera associated with the display device to capture an image of the second individual, if the viewing angle is less than a second predefined threshold value, the second predefined threshold value being less than the first predefined threshold value.
